(19) United States
(12) Patent Application Publication
(10) Pub. No.: US 2011/0204553 A1
(43) Pub. Date: Aug. 25, 2011

(54) PART DRAINING HANGER

(75) Inventors: Darryn Scott JARRETT, Lincoln, IL (US); Roger Wayne LANTER, Springfield, IL (US); Max Gerard FLECK, Petersburg, IL (US); Brad Scott GILMORE, Bloomington, IL (US)

(73) Assignee: EATON CORPORATION, Cleveland, OH (US)

(21) Appl. No.: 12/712,265

(22) Filed: Feb. 25, 2010

(51) Int. Cl. B23Q 1/00; B23Q 7/00

(52) U.S. Cl. 269/46; 29/559

(57) ABSTRACT

A part hanger is provided that engages a part being treated in a manner that orients the part so that treatment liquid tends to drain from the part. To this end, a part hanger is provided that is configured to suspend a part for treatment with a liquid. The part hanger includes one or more elongate members formed into a substantially U-shape having first and second side legs connected by a bottom leg. The first leg is configured to support a portion of the part from below at a first leg distal end. A hanger extension is connected at one end to a second leg distal end. The hanger extension is disposed substantially parallel to the bottom leg and terminates at a hanger extension distal end in a mounting feature. The hanger extension terminates prior to contacting the first leg distal end such that the first leg distal end and the mounting feature define a part clearance gap through which at least a portion of the part may extend into the U-shape.

### BACKGROUND

When parts with interior cavities are treated by spraying or dipping, residual treatment liquid may become trapped in the interior cavities. Allowing time for the residual liquid to drain in between processing steps increases the processing time required to treat parts. In some circumstances it is not feasible to wait until all of the residual liquid has drained. If adequate time is not provided between treatment steps to allow the trapped liquid to drain, the residual liquid may contaminate liquid used in a subsequent processing step. This contamination makes it necessary to drain and dispose of the contaminated liquid, which is costly and time consuming.

### SUMMARY

A part hanger is provided that engages a part being treated in a manner that orients the part so that treatment liquid tends to drain from the part. To this end, a part hanger is provided that is configured to suspend a part for treatment with a liquid. The part hanger includes one or more elongate members formed into a substantially U-shape having first and second side legs connected by a bottom leg. The first leg is configured to support a portion of the part from below at a first leg distal end. A hanger extension is connected at one end to a second leg distal end. In some example embodiments, the angle between the hanger extension and the second side leg is obtuse. The hanger extension is disposed substantially parallel to the bottom leg and terminates at a hanger extension distal end in a mounting feature. The hanger extension terminates prior to contacting the first leg distal end such that the first leg distal end and the mounting feature define a part clearance gap through which at least a portion of the part may extend into the U-shape. In some example embodiments, the hanger extension terminates less than half the distance between the first and second side leg distal ends.

In some example embodiments, the first, second, bottom legs and the hanger extension are formed from the same elongate member. The mounting feature may include an s-shaped hook that made up of first and second U-shaped hook portions that share a common middle leg. The first U-shaped hook portion is configured to hang on a mounting rack and the second U-shaped hook portion includes the common middle leg and the hanger extension.

In another example embodiment, an enclosure hanger is provided for suspending an enclosure for treatment with a liquid. The enclosure includes enclosure walls connected at respective rear edges to an enclosure floor to define an interior and the enclosure walls define an opening opposite the enclosure floor. The enclosure hanger includes an elongate member having a first distal end configured to contact an interior-facing surface of a top enclosure wall at an engagement point proximate to the rear edge of the top enclosure wall. The engagement point is selected relative to a center of gravity of the enclosure such that when the first distal end supports the enclosure at the engagement point, the enclosure orients in a position that places the enclosure floor above the enclosure opening to cause liquids to tend to drain from the enclosure.

The elongate member is formed to define an open interior hanger region into which the one of the enclosure walls supported by the first distal end extends when the enclosure is installed on the enclosure hanger. The interior hanger region is bounded by first and second side legs, a bottom leg, and a hanger extension that extends from the second side leg part of the way to the first distal end and terminates in a mounting feature disposed at a distal end of the hanger extension. The mounting feature and the first distal end define an enclosure clearance gap through which the one of the enclosure walls enters the interior hanger region.

According to another example embodiment, a method is provided for mounting an enclosure for treatment with a liquid. The enclosure includes enclosure walls connected at respective rear edges to an enclosure floor to define an interior, and the enclosure walls define an opening opposite the enclosure floor. The method includes inserting a top enclosure wall through an enclosure clearance gap defined between a first distal end of an enclosure hanger and a mounting feature disposed proximate a second distal end of the enclosure hanger. The top enclosure wall in thus positioned in an interior hanger region defined by first and second side legs, a bottom leg, and a hanger extension that extends from the second side leg part of the way to the first distal end and terminates in the mounting feature disposed at a distal end of the hanger extension.

The method also includes contacting an interior-facing surface of the top enclosure wall with the first distal end at an engagement point proximate to a rear edge of the top enclosure wall. The engagement point is selected relative to a center of gravity of the enclosure such that when the first distal end supports the enclosure at the engagement point, the enclosure orients in a position that places the enclosure floor above the enclosure opening to cause liquids to tend to drain from the enclosure.

In one example embodiment, the method includes inserting the top wall through an enclosure clearance gap of a second enclosure hanger and contacting the interior-facing surface of the top enclosure wall with the first distal end of the second enclosure hanger. The method may also include capturing liquid that drains from the enclosure after treatment by the liquid while the enclosure is supported by the enclosure hanger.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side cross section view of a prior art hanger suspending an enclosure.

FIG. 2 is front view of an example embodiment of a hanger constructed in accordance with the present invention.

FIG. 3 is a side cross section view of three enclosures being suspended by the hanger of FIG. 2.

FIG. 4 is a perspective view of nine enclosures being suspended on a rack that includes eighteen of the hangers of FIG. 2.

### DETAILED DESCRIPTION

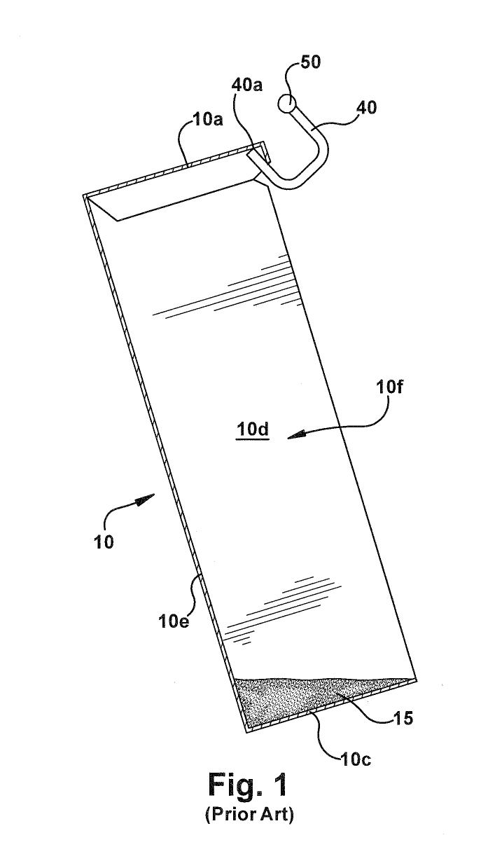

FIG. 1 illustrates a prior art part hanger 40 that is used to suspend an enclosure 10 for treatment by a liquid, such as, for example, paint or other coating. The enclosure includes four walls, three of which 10a, 10c, 10d are visible in the cross section of FIG. 1. The four walls are connected to an enclosure floor 10e at their respective rear edges. The front edges of the four walls define an enclosure opening 10f. The enclosure may be a housing for an electrical meter or power outlet. While this description will describe a part hanger being used to suspend an enclosure for treatment by a liquid, it is to be understood that the part hanger may be advantageously employed with a wide range of parts that have interior cavities that tend to trap residual treatment liquid.

The part hanger 40 has a U-shape with a distal end 40a configured to support a front edge of the top wall 10a for treatment with a liquid. The part hanger 40 is connected to a rack 50 that may mount several hangers for treatment of multiple enclosures. As can be seen in FIG. 1, the part hanger 40 suspends the enclosure such that the enclosure floor 10e is below the opening 10f, allowing residual treatment liquid 15 to pool along a bottom rear edge of the enclosure. If the liquid 15 is not allowed to drain prior to a next treatment step, the liquid 15 will mix with a subsequent treatment liquid and drain into a reclamation tank. This will contaminate the subsequent treatment liquid, requiring draining and disposal of the treatment liquid, and incurring monetary and environmental costs.

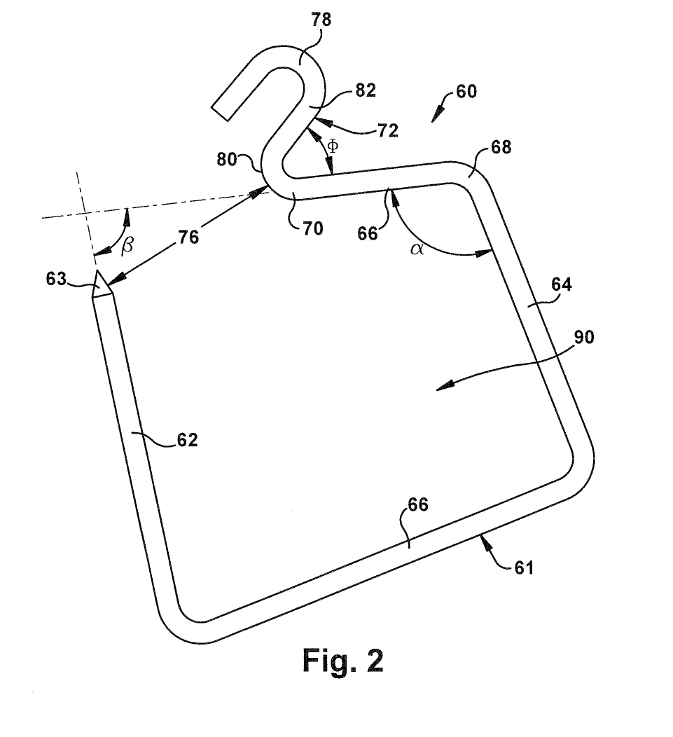

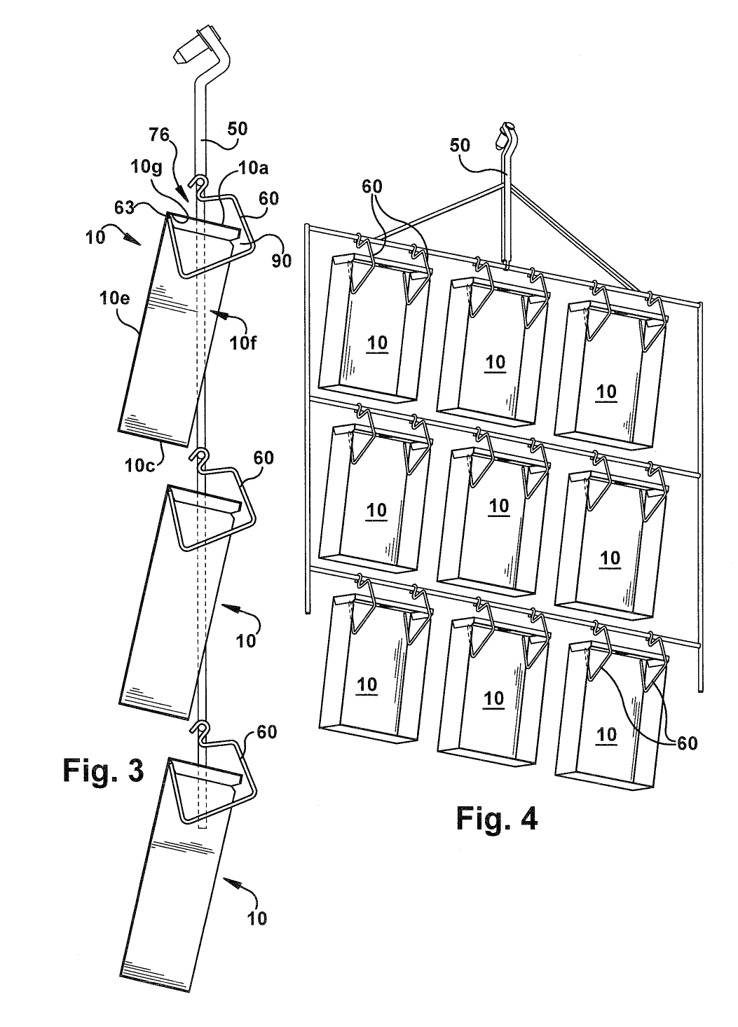

FIG. 2 illustrates an example embodiment of a part hanger 60 that is configured to position parts so that residual liquid is not retained by the part. In one example embodiment, the part hanger 60 is used as an enclosure hanger as shown in FIGS. 3 and 4. The part hanger 60 includes a U-shaped portion made up of a first side leg 62, a bottom leg 66, and a second side leg 64. A hanger extension 66 extends from a second leg distal end 68 toward a first leg distal end 63. The hanger extension 66 is disposed substantially parallel to the bottom leg 66 at a slightly obtuse angle α with respect to the second side leg 64. In one particular embodiment, the angle α is approximately 105°.

The hanger extension 66 terminates at a hanger extension distal end 70 that includes a mounting feature 72 configured to be mounted on the rack 50 (shown in FIGS. 1, 3, 4). The hanger extension 66 extends approximately half the distance to the first leg distal end 63. In the illustrated embodiment, the hanger extension 66 is oriented at a slightly acute angle β with respect to the first side leg 62. In one embodiment, the angle β is approximately 85°. A part clearance gap 76 is defined between the hanger extension distal end 70 and the first leg distal end 63. The part clearance gap allows a portion of the part being suspended by the hanger 66 to extend into an interior hanger region 90 bounded by the first and second side legs 62, 64, the bottom leg 66, and the hanger extension 66. In the illustrated embodiment, the hanger 60, including the mounting feature 72, is formed from a single elongate member 61.

The mounting feature 72 is S-shaped, comprising a first U-shaped hook portion 78 configured to fit around the rack 50 (not shown in FIG. 2). The first U-shaped hook portion may be hung on the rack or fixed, such as by welding, to the rack. The mounting feature 72 includes a second U-shaped hook portion 80 that shares a common leg 82 with the first U-shaped hook portion 78. The second U-shaped hook portion 80 also includes as its second leg the hanger extension 66. The second U-shaped hook portion 80 orients the hanger extension 66 with respect to the first U-shaped hook portion 78 (and thus the rack 50) according to an angle φ. In one embodiment, the angle φ is approximately 45°. The angles α, β, and φ are selected to properly align the first leg distal end 63 with the center of gravity of the part (not shown) so that the part is able to be suspended partially within the interior hanger region 90 and will rest on the first distal end 64 in a position that tends to drain residual fluid from the part. While an S-shaped mounting feature 72 is described herein, it will be apparent to one of skill in the art that any suitable mounting feature that connects the hanger extension 66 to the rack 50 in a manner that properly orients the part for draining may be used. For example, the hanger extension distal end 70 may be fixed directly to the rack 50.

FIGS. 3 and 4 illustrate an example embodiment of the rack 50 having a plurality of pairs of hangers 60 mounted thereto for suspending one or more enclosures 10. To utilize each hanger 60, the top enclosure wall 10a is inserted through the clearance gap 76 and into the interior hanger region 90. An interior-facing surface of the top enclosure wall 10a is contacted with the first distal end 63 at an engagement point 10g proximate to a rear edge of the top enclosure wall. The engagement point is selected relative to a center of gravity of the enclosure such that when the first distal end 63 supports the enclosure 10 at the engagement point 10g, the enclosure orients in a position that places the enclosure floor 10e above the enclosure opening 10f to cause liquids to tend to drain from the enclosure. In this manner, liquid that drains from the enclosure after treatment by the liquid may be captured while the enclosure is supported by the enclosure hanger.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

What is claimed is:

1. A part hanger configured to suspend a part for treatment with a liquid comprising:
one or more elongate members formed into a substantially U-shape having first and second side legs connected by a bottom leg;
where the first leg is configured to support a portion of the part from below at a first leg distal end; and
a hanger extension comprising another elongate member connected at one end to a second leg distal end, the hanger extension disposed substantially parallel to the bottom leg and terminating at a hanger extension distal end in a mounting feature, the hanger extension terminating prior to contacting the first leg distal end such that the first leg distal end and the mounting feature define a part clearance gap through which at least a portion of the part may extend into the U-shape.

2. The part hanger of claim 1 where the first, second, bottom legs and the hanger extension are formed from the same elongate member.

3. The part hanger of claim 1 where the mounting feature comprises an s-shaped hook that includes first and second U-shaped hook portions that share a common middle leg, where the first U-shaped hook portion is configured to hang on a mounting rack and the second U-shaped hook portion comprises the common middle leg and the hanger extension.

4. The part hanger of claim 3 where the common middle leg forms an angle of approximately 45 degrees with respect to the hanger extension.

5. The part hanger of claim 1 where the hanger extension terminates less than half the distance between the first and second side leg distal ends.

6. The part hanger of claim 1 where the angle between the angle between the hanger extension and the second side leg is obtuse.

7. An enclosure hanger for suspending an enclosure for treatment with a liquid, where the enclosure includes enclosure walls connected at respective rear edges to an enclosure floor to define an interior, the enclosure walls defining an opening opposite the enclosure floor, the enclosure hanger comprising:
an elongate member having a first distal end configured to contact an interior-facing surface of a top enclosure wall at an engagement point proximate to the rear edge of the top enclosure wall, where the engagement point is selected relative to a center of gravity of the enclosure such that when the first distal end supports the enclosure at the engagement point, the enclosure orients in a position that places the enclosure floor above the enclosure opening to cause liquids to tend to drain from the enclosure;
the elongate member formed to define an open interior hanger region into which the one of the enclosure walls supported by the first distal end extends when the enclosure is installed on the enclosure hanger;
the interior hanger region bounded by first and second side legs, a bottom leg, and a hanger extension that extends from the second side leg part of the way to the first distal end and terminates in a mounting feature disposed at a distal end of the hanger extension; and
where the mounting feature and the first distal end define an enclosure clearance gap through which the one of the enclosure walls enters the interior hanger region.

8. The enclosure hanger of claim 7 where the mounting feature comprises an S-shaped hook that includes first and second U-shaped hook portions that share a common middle leg, where the first U-shaped hook portion is configured to hang on a mounting rack and the second U-shaped hook portion comprises the common middle leg and the hanger extension.

9. The enclosure hanger of claim 8 where the common middle leg forms an angle of approximately 45 degrees with respect to the hanger extension.

10. The enclosure hanger of claim 7 where the hanger extension terminates less than half the distance between the second side leg and the first distal end.

11. The enclosure hanger of claim 7 where the angle between the hanger extension and the second side leg is obtuse.

12. A method that suspends an enclosure for treatment with a liquid, where the enclosure includes enclosure walls connected at respective rear edges to an enclosure floor to define an interior, the enclosure walls defining an opening opposite the enclosure floor, the method comprising:
inserting a top enclosure wall through an enclosure clearance gap defined between a first distal end of an enclosure hanger and a mounting feature disposed proximate a second distal end of the enclosure hanger and into an interior hanger region defined by first and second side legs, a bottom leg, and a hanger extension that extends from the second side leg part of the way to the first distal end and terminates in the mounting feature disposed at a distal end of the hanger extension; and
contacting an interior-facing surface of the top enclosure wall with the first distal end at an engagement point proximate to a rear edge of the top enclosure wall, where the engagement point is selected relative to a center of gravity of the enclosure such that when the first distal end supports the enclosure at the engagement point, the enclosure orients in a position that places the enclosure floor above the enclosure opening to cause liquids to tend to drain from the enclosure.

13. The method of claim 12 comprising:
inserting the top wall through an enclosure clearance gap of a second enclosure hanger; and
contacting the interior-facing surface of the top enclosure wall with the first distal end of the second enclosure hanger.

14. The method of claim 12 comprising capturing liquid that drains from the enclosure after treatment by the liquid while the enclosure is supported by the enclosure hanger.

15. An apparatus that suspends an enclosure for treatment with a liquid, where the enclosure includes enclosure walls connected at respective rear edges to an enclosure floor to define an interior, the enclosure walls defining an opening opposite the enclosure floor, the apparatus comprising:
means for contacting an interior-facing surface of a top enclosure wall with a first distal end of a hanger at an engagement point proximate to a rear edge of the top enclosure wall, where the engagement point is selected relative to a center of gravity of the enclosure such that when the first distal end supports the enclosure at the engagement point, the enclosure extends into an interior hanger region and orients in a position that places the enclosure floor above the enclosure opening to cause liquids to tend to drain from the enclosure.
